(19) United States
(12) Patent Application Publication
(10) Pub. No.: US 2024/0414461 A1
(43) Pub. Date: Dec. 12, 2024

(54) ACTIVE VIOLIN SHOULDER RESTS

(71) Applicant: Seth Thorn, Scottsdale, AZ (US)

(72) Inventor: Seth Thorn, Scottsdale, AZ (US)

(21) Appl. No.: 18/809,107

(22) Filed: Aug. 19, 2024

Related U.S. Application Data
(63) Continuation of application No. PCT/US2023/013630, filed on Feb. 22, 2023.
(60) Provisional application No. 63/315,842, filed on Mar. 2, 2022.

(51) Int. Cl. H04R 1/02; G06F 3/16; G10D 3/18; H04R 1/46; H04R 3/12

(52) U.S. Cl. CPC H04R 1/028; G06F 3/162; G10D 3/18; H04R 1/025; H04R 1/46; H04R 3/12; H04R 2201/028

(57) ABSTRACT

Disclosed herein are active shoulder rests that include sound diffusion speakers and actuators. In embodiments, the ASRs also include an amplifier to which the sound diffusion speakers and actuators are connected.

### CROSS-REFERENCE TO RELATED APPLICATION

This application is a continuation of PCT Application No. PCT/US2023/013630 filed on Feb. 22, 2023, now WIPO publication WO 2023/167797 entitled “ACTIVE VIOLIN SHOULDER RESTS.” PCT/US2023/013630 claims priority to and the benefit of U.S. Provisional Patent Application No. 63/315,842 filed on Mar. 2, 2022 entitled “ACTIVE VIOLIN SHOULDER RESTS.” The disclosure of each of the foregoing applications is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to active shoulder rests (ASRs) that contain sound diffusion speakers and actuators.

### BACKGROUND

A shoulder rest is a device used by violinists/violists for ergonomic support and proper somatic alignment that attaches to the lower part of the instrument's back. It raises the violin above the shoulder, bringing it closer to the player's chin so that the instrument can be held in place without neck strain or compensatory shoulder lifting. Since it helps to mitigate the adoption of awkward postures, most violinists adopt a shoulder rest in some form. Indicative of this is the fact that commercial violin and viola cases include a pocket or additional space intended for storing one. Many commercial form factors are available, but the most widely used is a simple, thin bar of wood or plastic with a curvature conforming to the shoulder and collarbone, with a foam pad for comfort and ergonomic adhesion.

Violin shoulder rests present an unrecognized opportunity for instrument augmentation. Previously, an ASR was developed by adding two voice-coil actuators to a modified commercial shoulder rest. This original model gives strong vibratory haptic feedback to the upper chest and actuates the violin at greater amplitudes due to the physical coupling. The ASR creates an “active acoustic instrument” by adding an electronic soundscape that radiates from the acoustic body and doubles the gestural excitement produced by the player. Using this device, violinists can expand the expressive range of their instruments, altering their acoustic presence without intrusive or permanent modifications.

The active acoustics principle has some limitations. By actuating the body of an acoustic instrument, active acoustics are spectrally idiosyncratic. Moreover, unless a performer deliberately intends to explore feedback musicianship (self-resonance) by closing the loop, it is preferable that amplification levels remain low.

A variety of violin-related HCl projects have been created and presented over the last few decades. It may be that a violin shoulder rest presents a rather singular opportunity in that it, on the one hand, is an already ubiquitous, desirable, and familiar accessory, and on the other, is uniquely situated in performance as both part of the violin and the sensorium of the human performer.

### SUMMARY

In an aspect, an active shoulder rest is provided, comprising at least one sound diffusion speaker; at least one actuator; and at least one amplifier, wherein the at least one sound diffusion speaker and the at least one actuator are connected to the at least one amplifier.

In embodiments, the active shoulder rest further comprises an ABS cabinet that embeds the at least one sound diffusion speaker. In embodiments, the at least one sound diffusion speaker comprises three speakers that are embedded in the ABS cabinet. In embodiments, the three speakers comprise a 5 watt driver and two 13 mm drivers.

In embodiments, the at least one actuator comprises at least two voice-coil actuators. In embodiments, the at least one amplifier comprises an Adafruit MAX98306.

In embodiments, the active shoulder rest further comprises a port configured for a detachable condenser or a contact microphone.

In embodiments, the active shoulder rest further comprises a condenser that is attached to the port. In embodiments, the active shoulder rest further comprises a contact microphone that is attached to the port.

In embodiments, the active shoulder rest further comprises a jack configured to couple differential stereo input signals and to power a daughter board.

In an aspect, an active shoulder rest is provided, comprising a body comprising an array of speakers; at least one actuator; at least one amplifier, wherein the array of speakers and the least one actuator are connected to the at least one amplifier; and damping material that is within the body.

In embodiments, the active shoulder rest further comprises a port configured such that a microphone pickup can be attached to the port. In embodiments, the active shoulder rest further comprises a microphone pickup attached to the port.

In embodiments, the at least one amplifier comprises an Adafruit MAX98306.

In an aspect, a system is provided comprising at least one sound diffusion speaker; at least one actuator; at least one amplifier, wherein the at least one sound diffusion speaker and the at least one actuator are connected to the amplifier; and at least one port configured for a microphone pickup.

In embodiments, the port is configured such that a detachable condenser microphone can be attached to the port. In embodiments, the port is configured such that a contact microphone can be attached to the port.

In embodiments, the system further comprises a daughter board that is configured to connect to a computer interface. In embodiments, the system further comprises a computer interface connected to the daughter board, wherein the computer interface is configured for signal processing.

In embodiments, the computer interface comprises an application configured to implement signal processing that is designed to transform natural sound of a stringed instrument.

It is to be understood that any respective features/examples of each of the aspects of the disclosure as described herein may be implemented together in any appropriate combination, and that any features/examples from any one or more of these aspects may be implemented together with any of the features of the other aspect(s) as described herein in any appropriate combination to achieve the benefits as described.

### BRIEF DESCRIPTION OF THE DRAWINGS

With reference to the following description and accompany drawings:

FIG. 1 illustrates a dual mode active shoulder rest (ASR), in accordance with an exemplary embodiment.

FIG. 2 illustrates an ASR mounted on the back of a violin, in accordance with an exemplary embodiment.

FIG. 3 illustrates a wood model ASR with a radial array of speakers, in accordance with an exemplary embodiment.

FIG. 4 illustrates a small form shoulder rest prototype, in accordance with an exemplary embodiment.

FIG. 5 illustrates a small form factor shoulder rest with an attached bespoke condenser microphone, in accordance with an exemplary embodiment.

FIG. 6 illustrates a shoulder rest with actuators and speaker drives without an amplifier or RJ45 port assembly, in accordance with an exemplary embodiment.

FIG. 7 illustrates a CAD capture showing placement of a large speaker, two small speakers, actuators, and other components, in accordance with an exemplary embodiment.

FIG. 8 illustrates a shoulder rest with a RJ45 and a 3.5 mm microphone jack on the left side of the shoulder rest, in accordance with an exemplary embodiment.

FIGS. 9 and 10 illustrate different views of ASRs disclosed herein, in accordance with exemplary embodiments.

FIG. 11 illustrates an ASR disclosed herein attached to a violin, in accordance with an exemplary embodiment.

FIG. 12 illustrates an old prototype of a shoulder rest that contains two embedded voice coil actuators, according with an exemplary embodiment.

### DETAILED DESCRIPTION

Disclosed herein are active shoulder rests (ASRs). In embodiments, the ASRs comprise at least one sound diffusion speaker. In embodiments, the ASRs further comprise an ABS cabinet that embeds that at least one sound diffusion speaker. In embodiments, the at least one sound diffusion speaker comprises two speakers or three speakers that are embedded in the ABS cabinet. In embodiments, the two speakers or three speakers comprise a 5 watt driver and two 13 mm drivers. In embodiments, the at least one actuator comprises at least two voice coil actuators. In embodiments, the at least one amplifier comprises an Adafruit MAX98306. In embodiments, the ASRs further comprise a port configured for a detachable condenser or a contact microphone. In embodiments, the ASRs further comprise a condenser that is attached to the port. In embodiments, the ASRs further comprise a contact microphone that is attached to the port. In embodiments, the ASRs further comprise a jack configured to couple differential stereo input signals and to power a daughter board.

In an aspect, an ASR is provided, comprising a body comprising at least one speaker; at least one actuator; at least one amplifier, wherein the array of speakers and that the least one actuator are connected to the at least one amplifier; and damping material that is within the body. In embodiments, the at least one speaker comprises one speaker, two speakers, three speakers, four speakers, five speakers, six speakers, seven speakers, eight speakers, nine speakers, or ten speakers. In embodiments, the at least one speaker comprises more than ten speakers. In embodiments, the at least one speaker comprises an array of speakers. In embodiments, the array of speakers are configured in a radial array.

In an aspect, an ASR is provided, comprising a body comprising at least one speaker and at least one actuator. In embodiments, the at least one speaker comprises one speaker, two speakers, three speakers, four speakers, five speakers, six speakers, seven speakers, eight speakers, nine speakers, or ten speakers. In embodiments, the at least one speaker comprises more than ten speakers. In embodiments, the at least one speaker comprises an array of speakers. In embodiments, the array of speakers are configured in a radial array. In embodiments, the at least one speaker comprises at least one sound diffusion speaker.

In an aspect, an ASR is provided comprising at least one speaker and at least one actuator.

In embodiments, any ASR described herein further comprises an ABS cabinet. In embodiments, the ABS cabinet embeds the at least one speaker. In embodiments, the ABS cabinet embeds at least one sound diffusion speaker.

In embodiments, any of the at least one actuator described herein comprises at least one voice coil. In embodiments, the at least one voice coil comprises two voice coils. In embodiments, the at least one voice coil comprises more than two voice coils.

In embodiments, any of the at least one actuator described herein comprises at least one linear resonant actuator. In embodiments, the at least one linear resonant actuator comprises two linear resonant actuators. In embodiments, the at least one linear resonant actuator comprises more than two linear resonant actuators.

In embodiments, any of the at least one actuator described herein comprises at least one eccentric rotating mass actuator. In embodiments, the at least one eccentric rotating mass actuator comprises two eccentric rotating mass actuators. In embodiments, the at least one eccentric rotating mass actuator comprises more than two eccentric rotating mass actuators.

In embodiments, any of the at least one actuator described herein comprises at least one piezoelectric actuator. In embodiments, the at least one piezoelectric actuator comprises two piezoelectric actuators. In embodiments, the at least one piezoelectric actuator comprises more than two piezoelectric actuators.

In embodiments, any of the least one actuator described herein comprises at least one linear actuator. In embodiments, any of the least one actuator described herein comprises at least one rotary actuator.

In embodiments, any of the ASRs disclosed herein further comprise a port configured for a microphone pickup. In embodiments, the ASR further comprises a microphone pickup attached to the port. In embodiments, any of the ASRs disclosed herein lack a port. In embodiments, the at least one amplifier comprises an Adafruit MAX98306.

In an aspect, a system is provided comprising at least one sound diffusion speaker; at least one actuator; at least one amplifier, wherein the at least one sound diffusion speaker and the at least one actuator are connected to the amplifier; and at least one port configured for a microphone pickup. In an aspect, a system is provided comprising at least one speaker and at least one actuator. In embodiments, the at least one speaker comprises at least one sound diffusion speaker. In embodiments, the system lacks a port.

In embodiments, any of the ports described herein are configured for a detachable condenser microphone. In embodiments, the port is configured for a contact microphone. In embodiments, the port comprises an RJ45 port assembly. In embodiments, the system further comprises a daughter board that is configured to connect to a computer interface. In embodiments, the system further comprises a computer interface connected to the daughter board, wherein the computer interface is configured for signal processing. In embodiments, the computer interface comprises an application configured to implement signal processing that is designed to transform the natural sound of a stringed instrument.

In an aspect, a system is provided comprising at least one speaker; at least one actuator; and at least one amplifier, wherein the at least one speaker and the at least one actuator are connected to the amplifier. In embodiments, the at least one speaker comprises at least one sound diffusion speaker.

In embodiments, any of the systems described herein further comprise a port assembly. In embodiments, the port assembly is configured to attach to a condenser. In embodiments, the port assembly is configured to attach to a contact microphone. In embodiments, any of the systems described herein lack a port assembly.

In embodiments, any of the systems described herein further comprise a computer interface connected to the daughter board. In embodiments, the computer interface is configured for signal processing. In embodiments, the computer interface comprises an application configured to implement signal processing that is designed to transform the natural sound of a stringed instrument. In an aspect, ASRs disclosed herein include one or more speakers. In embodiments, the ASRs disclosed herein include at least two speakers. In embodiments, ASRs disclosed herein include an array of speakers configured in a radial array.

In embodiments, the ASRs disclosed herein include two sets of speakers. In embodiments, the first set couples to the instrument body and allows the player to experiment with changing the sound characteristics of the instrument. In embodiments, the second set allows for spectrally flatter sound diffusion from the vicinity of the instrument. In embodiments, this technology allows for the sound of the instrument to be modified without permanent modifications.

In an aspect, an active shoulder rest is provided comprising at least one sound diffusion speaker and at least one actuator. In embodiments, the at least one sound diffusion speaker comprises one speaker, two speakers, three speakers, four speakers, five speakers, six speakers, seven speakers, eight speakers, nine speakers, or ten speakers. In embodiments, the at least one sound diffusion speaker comprises more than ten speakers. In embodiments, the at least one sound diffusion speaker comprises more than one speaker that are configured in a radial array. In embodiments, the active shoulder rest comprises an ABS cabinet that embeds that at least one sound diffusion speaker.

In an aspect, systems disclosed herein include any of the ASRs disclosed herein and signal processing algorithms capable of generating specific effects. In embodiments, the systems that include signal processing algorithms further comprises a port. In embodiments, the port is configured to attach to a condenser. In embodiments, the port is configured to attach to a contact microphone. In embodiments, systems that include signal processing algorithms lack a port.

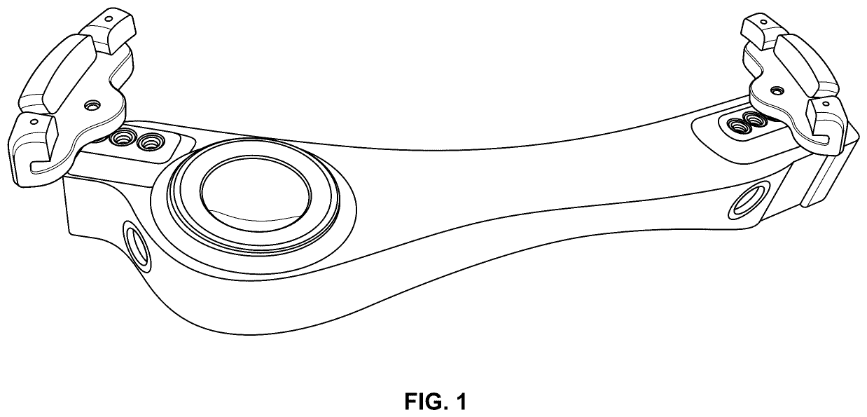

FIG. 1 depicts an exemplary embodiment of an ASR disclosed herein. The ASR is a “dual-mode” ASR with embedded actuators, 15 mm speaker drivers that project sound forward from the sides of the violin, and a larger 5-watt full-range driver. These components are housed in a sealed, dampened enclosure with a common shoulder rest form factor. The components are powered by a stereo class-D amplifier board (Adafruit MAX98306, 4 ohms @ 3 watts). A 3.5 mm jack on the end allows connection of a microphone, with bias provided by a daughter board with a preamplifier. Actuators and speakers connect to left and right channels, allowing differential use of diffusion/actuation. Fully differential stereo signals, microphone signal, and power are connected via an RJ45 jack.

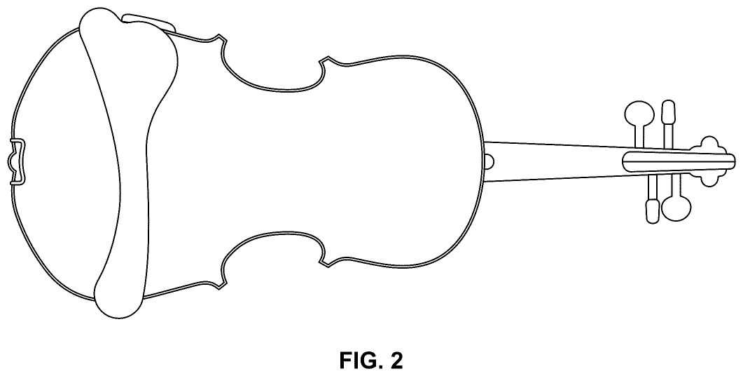

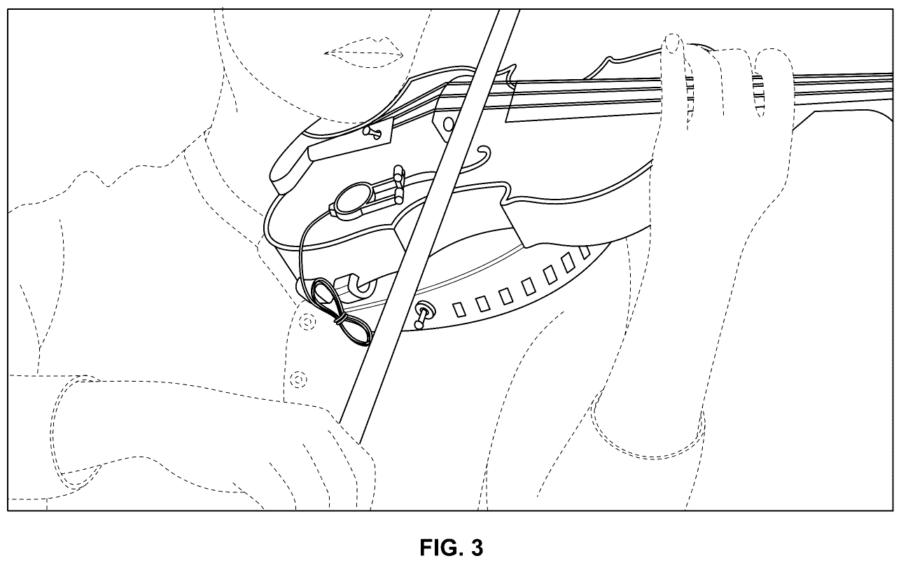

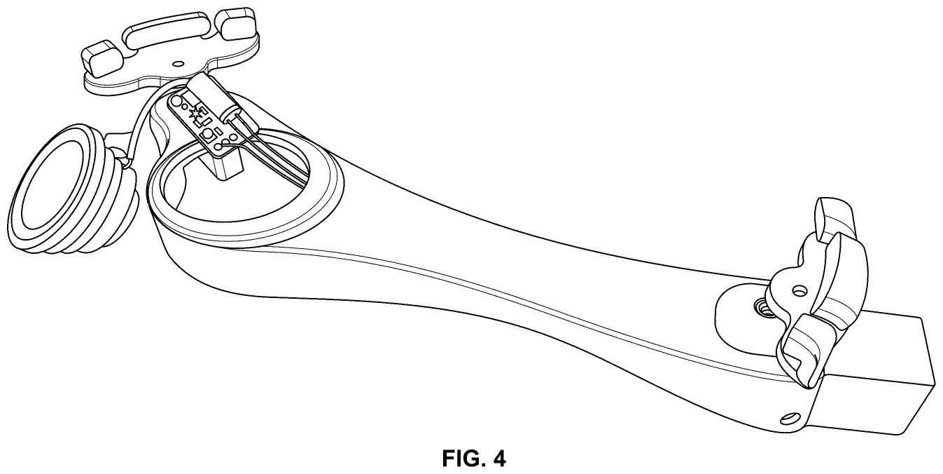

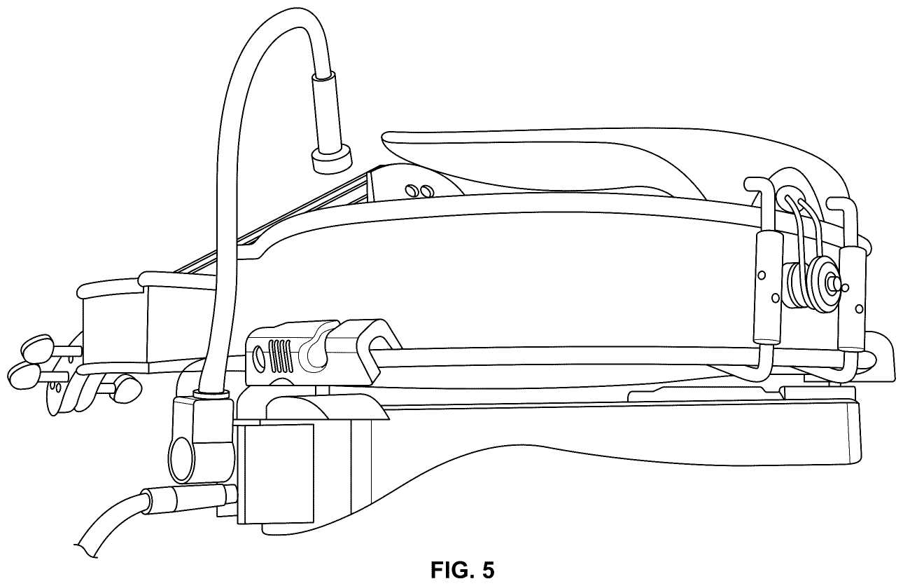

FIG. 2 depicts an ASR mounted on the back of a violin. The ASR depicted can be any of the ASRs described herein. FIG. 3 depicts a wood model ASR with a radial array of tiny speakers. A contact microphone attaches directly to the unit. FIG. 4 illustrates a design of a small form shoulder rest prototype. FIG. 5 illustrates a small form factor shoulder rest with an attached bespoke condenser microphone. The condenser microphone can be replaced with a contact microphone.

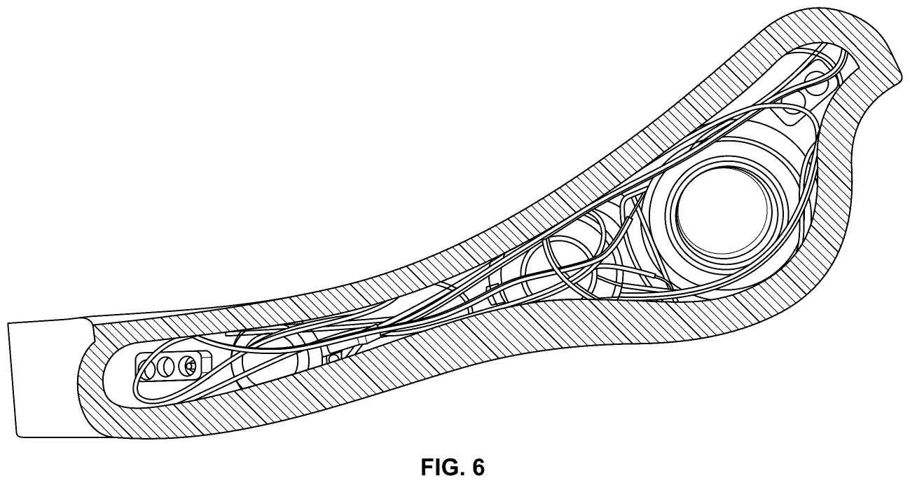

FIG. 6 depicts an ASR that shows the actuators and speaker drivers without the amplifier and RJ45 port assembly. The amplifier is adhered to the back of the large driver. The fit is tight due to a 2-watt resistor and 1000 UF electrolytic capacitor that was added.

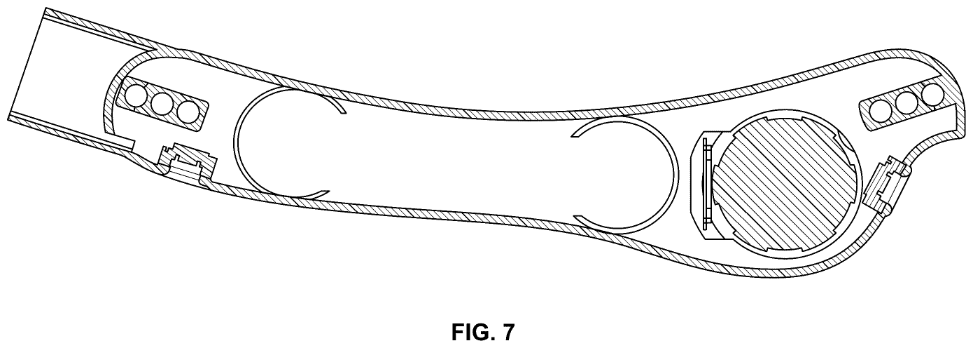

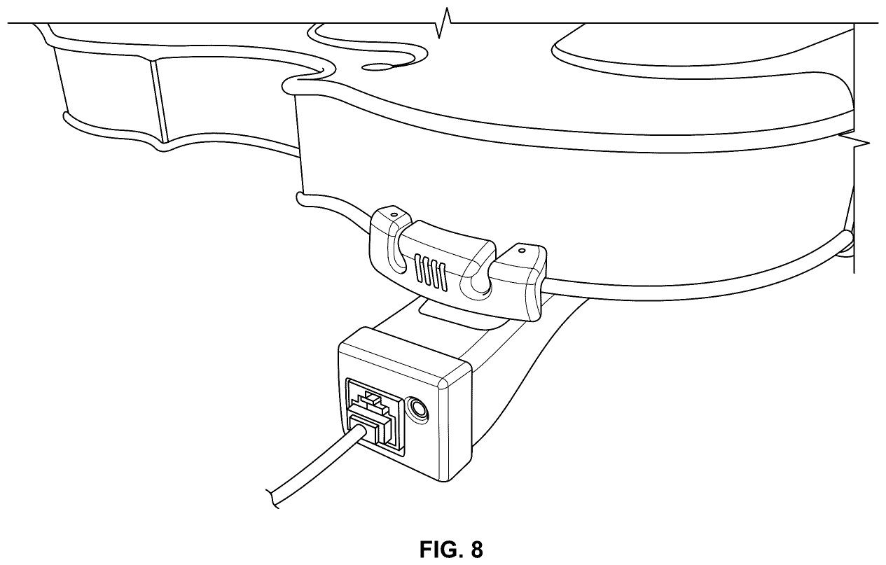

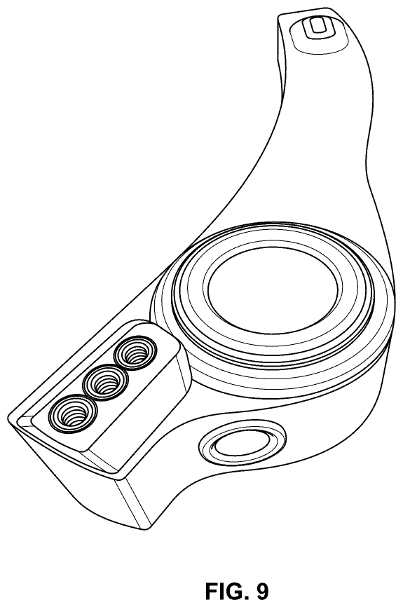

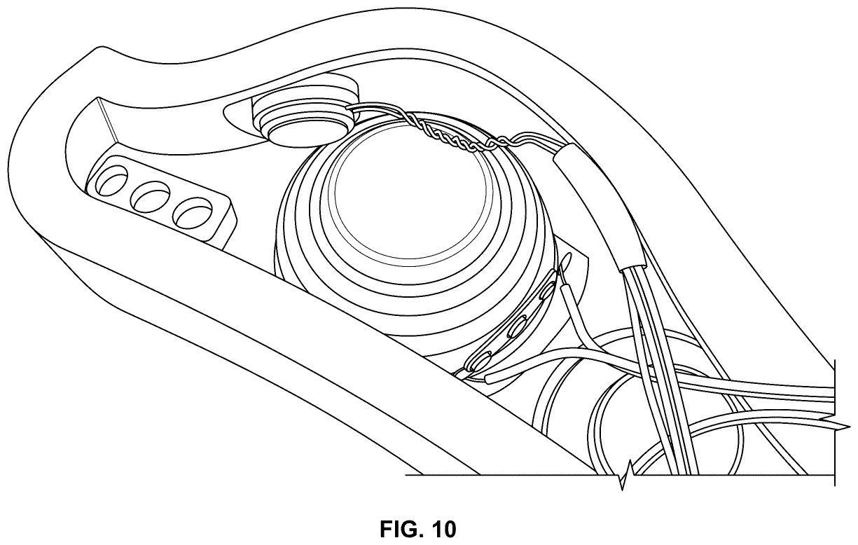

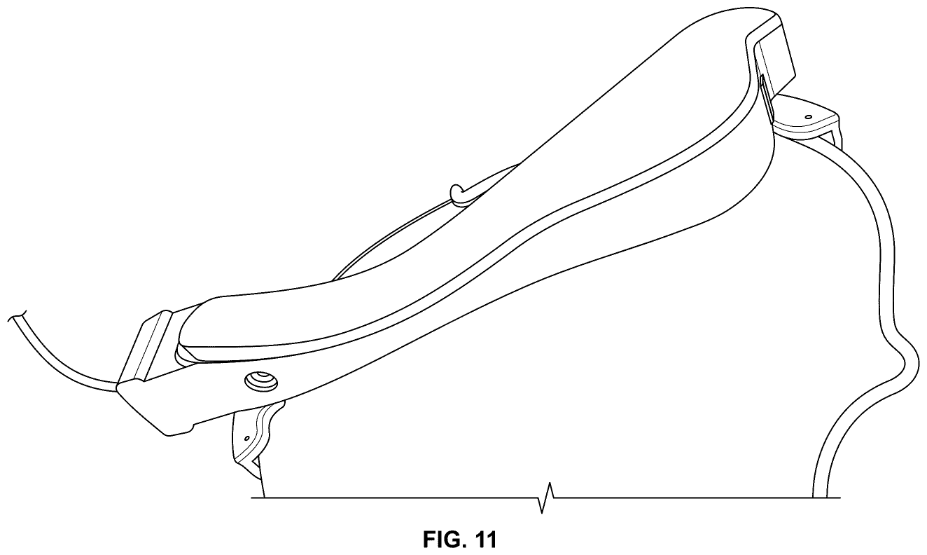

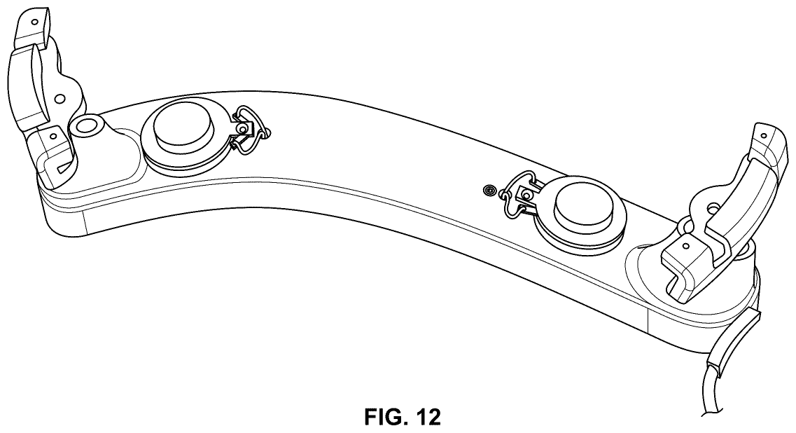

FIG. 7 illustrates a CAD capture showing placement of a large speaker, two small speakers, actuators, and other components. speakers, actuators, and other components, in accordance with an exemplary embodiment. FIG. 8 illustrates a shoulder rest with a RJ45 and a 3.5 mm microphone jack on the left side of the shoulder rest. FIGS. 9 and 10 illustrate different views of ASRs. The ASRs depicted can by any of the ASRs disclosed herein. FIG. 11 illustrates an ASR disclosed herein attached to a violin. FIG. 12 illustrates an old prototype of a shoulder rest that contains two embedded voice coil actuators.

### Augmented Shoulder Rests (ASRs)

Disclosed herein are ASRs that includes both actuation and sound diffusion hardware, allowing parametric control of mixing between a mode that leverages vibrotactile haptic feedback and active acoustics, and a second mode that provides spectrally flatter, co-located sound diffusion from the embedded speakers.

In embodiments, a traditional form factor is included to maintain the familiar feel and somatics of violin playing. This design choice makes ASRs disclosed herein viable as a traditional (passive) shoulder rest independently of its novel electronic functionalities, enabling the violinist to exchange their existing model for an ASR while progressively learning and growing into its novel potentialities.

ASRs can extend traditional acoustic instruments. In embodiments, the ASRs introduce a new tangible feedback, actuation, and/or sound diffusion elements.

### Embodiments of First Model ASRs

In embodiments, an ASR embeds two voice coils in an off-the-shelf commercial shoulder rest. In embodiments, the exciters are coupled to the digital sound output of a augmented violin system. In embodiments, an external amplifier is used to drive this model; differential stereo signals are coupled through a TRRS jack and cable. In embodiments, haptic feedback was coupled to the digital sound that can be felt by the performer. In embodiments, higher frequency sound was diffused by the ASR. In embodiments, the ASR incorporated miniature speaker cabinets.

In embodiments, larger models were constructed using circular arrays of small speakers. One of these models is handcrafted from wood and contains embedded DSP hardware (Bela Board Mini), WiFi connectivity, an amplifier, and a Lithium polymer battery.

In embodiments, the ASRs were designed within the constraints of the typical shoulder rest form factor, paring down the on-board electronics to a small monophonic class D amplifier (Adafruit PAM8302) and a bespoke condenser microphone on a flexible arm.

### Embodiments of Second Model ASRs

In embodiments, an ASR is provided that is a “dual mode” model that combines sound diffusion speakers and actuators. In embodiments, the sound diffusion speakers and the actuators are connected to an independent channel of an on-board stereo amplifier (e.g., Adafruit MAX98306). In embodiments, the 3D printed ABS cabinet embeds three speakers and two voice coil actuators.

In embodiments, damping material is added before sealing the enclosure. In embodiments the ASR contains the form factor of the earlier cabinet models while adding a larger amplifier, two actuators, two 15 mm drivers, a 2 watt resistor for impedance matching, and retaining a 1000 uF6 volt capacitor that prevents power supply pumping. In embodiments, the unit is sealed with a plastic insert, tape, and neoprene adhered to the rear of the unit. In embodiments, a 3.5 mm tip-sleeve jack is positioned on the rear for a detachable condenser or contact microphone. In embodiments, an RJ45 jack couples differential stereo input signals, the return microphone signal, and power to a daughter board, which uses a TS472 preamplifier to bias the microphone. In embodiments, the amplifier draws less than 400 mA or so, allowing the rest to be powered by a standard USB port. In embodiments, ASRs disclosed herein include both actuation and sound diffusion hardware, allowing parametric control of mixing between a mode that leverages vibrotactile haptic feedback and active acoustics, and a second mode that provides spectrally flatter, co-located sound diffusion from the embedded speakers.

In embodiments, saturating these devices with electronics and actuators opens a new design space for “active shoulder rests” (ASRs), a pathway for violinists to adopt a transparent electroacoustic interface. Disclosed herein are dual-mode ASRs that offer parametric control of mixing between sound diffusion and actuation modes for experiments with active acoustics. In embodiments, the ASR includes a port for a microphone pickup, including bias for a detachable condenser microphone (but a contact microphone can also be used). In embodiments, a small port connects the unit to a daughter board that can be connected to a computer USB audio interface for signal processing in commercial software. In embodiments, a specially designed application is provided that implements signal processing designed specifically to transform the natural sound of the violin using the speakers and/or actuators of the ASR. In embodiments, the left input channel is sent to the ASR speakers, while the right input channel is sent to its actuators. In embodiments, this enables the violinist to compose the transformed sound and feel of their instrument.

In embodiments, ASRs disclosed herein include an array of speakers for local sound diffusion in addition to the actuators, as well as offering an easy way for violinists to connect a microphone pickup to their instrument using the port we've built into the ASR. In embodiments, the ability to differentially send audio to the actuators and sound diffusion array means that a violinist can “compose” the sound and feel of their acoustic instrument very precisely. In embodiments, described herein is a library a signal processing and analysis techniques especially for violin. In embodiments, the ASRs disclosed herein lack a port.

In embodiments, the ASRs disclosed herein include embedded electronics, while maintaining the familiar size, shape, weight, and feel of a traditional shoulder rest. In embodiments, the embedded speakers and actuators can transform the sound of the instrument, provide a haptic metronome (similar to the commercial Soundbrenner Pulse watch), or be used pedagogically (e.g., with an embedded accelerometer, it could provide haptic feedback to the violinist telling them to lift the violin up more with the left hand to the ideal position, etc). In embodiments, the ASRs disclosed herein include a speaker array for local sound diffusion in addition to actuation. In embodiments, the speaker array comprises multiple speakers that are arranged in a radial pattern.

The topology of the project appears new in the musical instrument accessory market, which may be due to the unique affordances presented by shoulder rests. Another advantage of ASRs is that they are inexpensive to produce. In embodiments, the ASRs disclosed herein contain a small amplifier and several speaker drivers and actuators.

### Signal Processing & Performance Demonstrations

A range of uses can be conceived for ASRs, from minimal active acoustic doubling to bold use of self-resonant feedback that enacts a complex field of attractors.

In embodiments, the ASRs disclosed herein are approximately 157 grams. At 157 grams, the dual-mode model is twice as heavy as the commercial Everest EZ 4/4 model (˜80 grams), but nearly equivalent in weight to the popular Bonmusica shoulder rest (˜140 grams) with its metal body. Although adding weight to the base of the violin rather than the neck is not a problem so long as the added weight feels secure, keeping within the weight of heavier commercial shoulder rests is probably a good benchmark to follow. In embodiments, the ASRs disclosed herein are between 100 grams and 157 grams. In embodiments, the ASRs disclosed herein are between 157 grams and 200 grams. In embodiments, the ASRs disclosed herein are less than 100 grams. In embodiments, the ASRs disclosed herein are greater than 157 grams.

In embodiments, the ASR designs described herein can be used for uses beyond the sonic augmentation and transformation of the instrument described herein. In embodiments, the ASRs could provide synchronized, pulsed feedback to silently entrain multiple violinists to a tempo (similar to the Soundbrenner Pulse). In embodiments, the ASRs can also enhance embodied learning by providing sensory feedback related to pedagogical goals, e.g., using tilt sensing and feedback to encourage keeping the violin in an upright rather than sagging position, a common problem for novices. In embodiments, small cameras could use edge detection and embedded machine learning to track the angle of the bowing shoulder, forearm, and/or wrist, which are important pedagogical considerations that usually require assiduous long term observation and feedback by a skilled teacher. In embodiments, accessories such as a wrist sensor could be worn for tracking and responding to bowing characteristics. In embodiments, for an enhanced low-end response, a portable subwoofer could be wirelessly tethered to the device using a simple analog radio transmitter. In embodiments, miniaturization of DSP could eliminate the need for an off-board computer.

While various illustrative examples are described above, it will be apparent to one skilled in the art that various changes and modifications may be made therein without departing from the disclosure. It is to be understood that any respective features/examples of each of the aspects of the disclosure as described herein may be implemented together in any appropriate combination, and that any features/examples from any one or more of these aspects may be implemented together with any of the features of the other aspect(s) as described herein in any appropriate combination to achieve the benefits as described herein.

What is claimed is:

1. An active shoulder rest, comprising:
at least one sound diffusion speaker;
at least one actuator; and
at least one amplifier,
wherein the at least one sound diffusion speaker and the at least one actuator are connected to the at least one amplifier.

2. The active shoulder rest of claim 1, further comprising an ABS cabinet that embeds the at least one sound diffusion speaker.

3. The active shoulder rest of claim 2, wherein the at least one sound diffusion speaker comprises three speakers that are embedded in the ABS cabinet.

4. The active shoulder rest of claim 3, wherein the three speakers comprise a 5 watt driver and two 13 mm drivers.

5. The active shoulder rest of claim 1, wherein the at least one actuator comprises at least two voice coil actuators.

6. The active shoulder rest of claim 1, wherein the at least one amplifier comprises an Adafruit MAX98306.

7. The active shoulder rest of claim 1, further comprising a port configured for a detachable condenser or a contact microphone.

8. The active shoulder rest of claim 7, further comprising a condenser that is attached to the port.

9. The active shoulder rest of claim 7, further comprising a contact microphone that is attached to the port.

10. The active shoulder rest of claim 1, further comprising a jack configured to couple differential stereo input signals and to power a daughter board.

11. A system, comprising:
at least one sound diffusion speaker;
at least one actuator;
at least one amplifier,
wherein the at least one sound diffusion speaker and the at least one actuator are connected to the amplifier;
and at least one port configured for a microphone pickup.

12. The system of claim 11, wherein the port is configured for a detachable condenser microphone.

13. The system of claim of claim 12, wherein the port is configured for a contact microphone.

14. The system of claim 11, further comprising a daughter board that is configured to connect to a computer interface.

15. The system of claim 14, further comprising a computer interface connected to the daughter board, wherein the computer interface is configured for signal processing.

16. The system of claim 15, wherein the computer interface comprises an application configured to implement signal processing that is designed to transform natural sound of a stringed instrument.
